(19) United States
(12) Patent Application Publication
(10) Pub. No.: US 2025/0054260 A1
(43) Pub. Date: Feb. 13, 2025

(54) PAGE SWITCHING IN VIRTUAL ENVIRONMENT

(71) Applicant: Tencent Technology (Shenzhen) Company Limited, Shenzhen (CN)

(72) Inventor: Teng CHEN, Shenzhen (CN)

(73) Assignee: Tencent Technology (Shenzhen) Company Limited, Shenzhen (CN)

(21) Appl. No.: 18/929,305

(22) Filed: Oct. 28, 2024

Related U.S. Application Data
(63) Continuation of application No. PCT/CN2023/118136, filed on Sep. 12, 2023.

(30) Foreign Application Priority Data
Oct. 28, 2022 (CN) 202211336842.5

(51) Int. Cl. G06T 19/20; G06F 3/0483; G06F 3/0488

(52) U.S. Cl. CPC G06T 19/20; G06F 3/0483; G06F 3/0488; G06T 2219/2016

(57) ABSTRACT

In a method for switching pages in a virtual environment, a first page including at least one virtual object is displayed in a first virtual environment. A first magnification operation is received. The first page is magnified to display a magnified first page based on the first magnification operation. When the first magnification operation meets a trigger condition associated with a first virtual object, the display of the magnified first page is transitioned to display of a second page corresponding to the first virtual object. Apparatus and non-transitory computer-readable storage medium counterpart embodiments are also contemplated.

### RELATED APPLICATIONS

The present application is a continuation of International Application No. PCT/CN2023/118136, filed on Sep. 12, 2023, which claims priority to Chinese Patent Application No. 202211336842.5, filed on Oct. 28, 2022. The entire disclosures of the prior applications are hereby incorporated by reference.

### FIELD OF THE TECHNOLOGY

This application relates to the field of computer technologies, including switching pages in a virtual environment.

### BACKGROUND OF THE DISCLOSURE

A virtual social scenario includes elements such as different scenario areas and virtual characters. In addition, the different scenario areas represent different ranges of social scenarios. To increase fun of virtual social interaction, a user may select, based on a requirement of the user, a scenario area such as a friend square or a study room for learning that the user wants to enter.

In the related art, a next or previous level scenario of the scenario area is entered mainly by tapping an interactive element. In other words, page switching is implemented through a tapping operation. For example, by tapping a target virtual character, the user may enter a detail page of the target virtual character, thereby implementing interaction with the target virtual character. However, if a current page is switched to the detail page after being magnified, a plurality of operations is required, resulting in a technical problem of low operation efficiency occurring during page switching.

In view of the foregoing problem, no effective solution has been provided yet.

### SUMMARY

Embodiments of this disclosure provide a page switching method, apparatus, and a non-transitory computer-readable storage medium to at least resolve a technical problem of low operation efficiency occurring during page switching. Examples of technical solutions in the embodiments of this disclosure may be implemented as follows:

An aspect of this disclosure provides a method for switching pages in a virtual environment. A first page including at least one virtual object is displayed in a first virtual environment. A first magnification operation is received. The first page is magnified to display a magnified first page based on the first magnification operation. When the first magnification operation meets a trigger condition associated with a first virtual object, the display of the magnified first page is transitioned to display of a second page corresponding to the first virtual object.

An aspect of this disclosure provides an apparatus. The apparatus includes processing circuitry configured to display a first page including at least one virtual object in a first virtual environment. The processing circuitry is configured to receive a first magnification operation. The processing circuitry is configured to magnify the first page to display a magnified first page based on the first magnification operation. When the first magnification operation meets a trigger condition associated with a first virtual object, the processing circuitry is configured to transition from the display of the magnified first page to display of a second page corresponding to the first virtual object.

An aspect of this disclosure provides a non-transitory computer-readable storage medium storing instructions which when executed by a processor cause the processor to perform any of the methods of this disclosure.

### BRIEF DESCRIPTION OF THE DRAWINGS

The accompanying drawings described herein are used to provide a further understanding of this disclosure, and constitute a part of this disclosure. Example embodiments of this disclosure and descriptions thereof are used to explain this disclosure, and do not constitute any inappropriate limitation to this disclosure.

FIG. 1 is a schematic diagram of an application scenario of a page switching method according to an embodiment of this disclosure.

FIG. 2 is a flowchart of a page switching method according to an embodiment of this disclosure.

FIG. 3 is a schematic diagram (1) of a page switching method according to an embodiment of this disclosure.

FIG. 4 is a schematic diagram of a magnification center of a first magnification operation according to an embodiment of this disclosure.

FIG. 5 is a schematic diagram (2) of a page switching method according to an embodiment of this disclosure.

FIG. 6 is a schematic diagram (3) of a page switching method according to an embodiment of this disclosure.

FIG. 7 is a schematic diagram (4) of a page switching method according to an embodiment of this disclosure.

FIG. 8 is a schematic diagram of implementing page switching by continuously performing a first magnification operation according to an embodiment of this disclosure.

FIG. 9 is a schematic diagram (5) of a page switching method according to an embodiment of this disclosure.

FIG. 10 is a schematic diagram of implementing page switching by continuously performing a first minification operation according to an embodiment of this disclosure.

FIG. 11 is an overall flowchart of a page switching method according to an embodiment of this disclosure.

FIG. 12 is a sequence diagram of a page switching method according to an embodiment of this disclosure.

FIG. 13 is a schematic structural diagram of a page switching apparatus according to an embodiment of this disclosure.

FIG. 14 is a schematic structural diagram of an electronic device according to an embodiment of this disclosure.

### DESCRIPTION OF EMBODIMENTS

To help a person skilled in the art better understand solutions of this disclosure, the technical solutions in embodiments of this disclosure are described below with reference to the accompanying drawings in the embodiments of this disclosure. The described embodiments are merely some rather than all of the embodiments of this disclosure. All other embodiments obtained by a person of ordinary skill in the art based on the embodiments of this disclosure shall fall within the protection scope of this disclosure.

In the specification, claims, and the accompanying drawings of this disclosure, the terms such as “first” and “second” are intended to distinguish between similar objects but do not necessarily indicate a specific order or sequence. Data used in this way is interchangeable in a suitable case, so that the embodiments of this disclosure described herein can be implemented in an order other than those illustrated or described herein. In addition, the terms “comprise”, “have”, and any variants thereof are intended to cover non-exclusive inclusion. For example, a process, a method, a system, a product, or a device that includes a series of operations or units is not necessarily limited to those explicitly listed operations or units, but may include other operations or units not explicitly listed or inherent to the process, the method, the product, or the device.

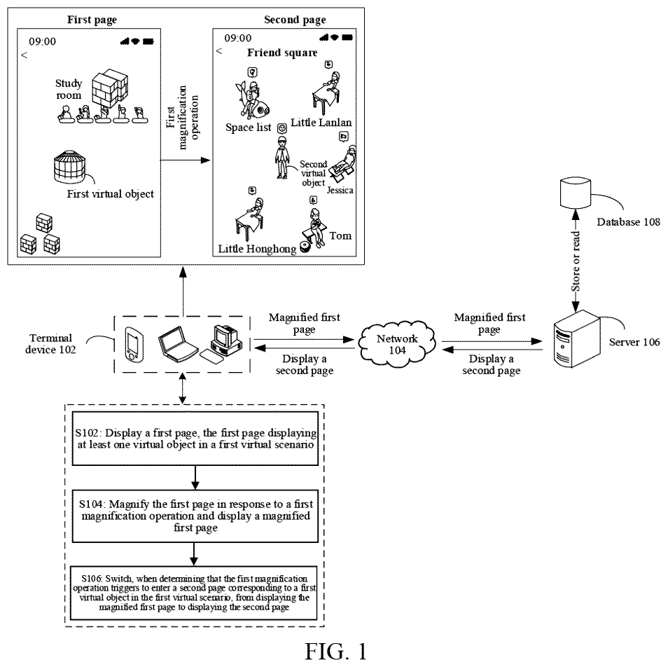

According to an aspect of the embodiments of this disclosure, a page switching method is provided. In an example implementation, the foregoing page switching method may be applied to, but not limited to, an application environment shown in FIG. 1. In the application scenario shown in FIG. 1, a terminal device 102 may, but not limited to, communicate with a server 106 through a network 104. The server 106 may, but not limited to, perform an operation such as a data writing operation or a data reading operation on a database 108. The foregoing terminal device 102 may include, but not limited to, a man-machine interaction screen, a processor, and a memory. The foregoing man-machine interaction screen may, but not limited to, be configured to display a virtual object in a first virtual scenario on the terminal device 102, a second page corresponding to a first virtual object, and the like. The foregoing processor may, but not limited to, be configured to, in response to a man-machine interaction operation, perform a corresponding operation, or generate corresponding instructions and transmit the generated instructions to the server 106. The foregoing memory is configured to store related processing data such as a trigger condition of a first magnification operation and a correspondence between the first virtual object and the second page.

In an example, the following operations in the page switching method may be performed on the server 106.

Operation S102: Display a first page, the first page displaying at least one virtual object in the first virtual scenario. For example, a first page including at least one virtual object is displayed in a first virtual environment.

Operation S104: Magnify the first page in response to the first magnification operation and display a magnified first page. For example, a first magnification operation is received. The first page is magnified to display a magnified first page based on the first magnification operation.

Operation S106: Switch, when determining that the first magnification operation triggers to enter the second page corresponding to the first virtual object in the first virtual scenario, from displaying the magnified first page to displaying the second page. For example, when the first magnification operation meets a trigger condition associated with a first virtual object, the display of the magnified first page is transitioned to display of a second page corresponding to the first virtual object.

In an example, execution bodies of the foregoing operations S102 to S106 are not limited in the embodiments. For example, the foregoing operations S102 to S106 all may be performed on the terminal device 102 or the server 106, or may be partially performed on the terminal device 102 and be partially performed on an operation server communicating with the server 106.

In the foregoing manner, in a case that the first magnification operation is performed on the first page, and the first magnification operation triggers to enter the second page corresponding to the first virtual object in the first virtual scenario, displaying the magnified first page is switched to displaying the second page corresponding to the first virtual object. It may be learnt that the first page may be magnified and automatically switched to the second page by performing only a single magnification operation on the first page.

However, in the related art, if a user wants to perform interaction on a magnified page and continue to perform interaction on a switched page, the user can perform only a magnification operation on a current page and perform interaction on a magnified current page, but cannot enter the switched page. In addition, a tapping operation further needs to be performed again to implement page switching.

Therefore, intermediate operating operations are reduced in this embodiment of this disclosure, to implement a dual function of page magnification and switching with one tap and reduce operation complexity, thereby resolving a technical problem of low operation efficiency occurring during page switching, and implementing a technical effect of improving operation efficiency.

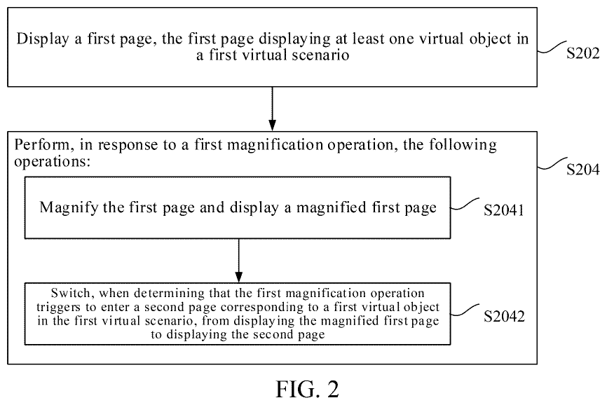

To resolve the foregoing problem of low operation efficiency occurring during page switching, an embodiment of this disclosure provides a page switching method. FIG. 2 is a flowchart of a page switching method according to this embodiment of this disclosure. A procedure includes the following operations.

Operation S202: Display a first page, the first page displaying at least one virtual object in a first virtual scenario. For example, a first page including at least one virtual object is displayed in a first virtual environment.

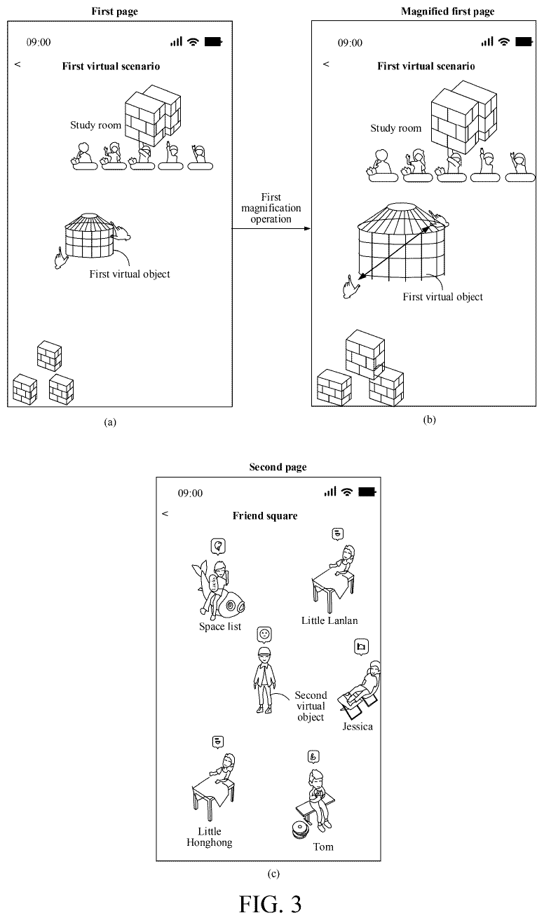

The first virtual scenario on the first page shown in FIG. 3(a) includes, but is not limited to, a plurality of virtual objects such as a virtual building and a virtual character. The virtual objects carry various social entrances in a form of a map. For example, a friend square may be entered through the virtual building. A detail page of the virtual character may be entered through the virtual character, for interaction between characters.

Operation S204: Perform the following operations S2041 and S2042 in response to a first magnification operation.

Operation S2041: Magnify the first page and display a magnified first page. For example, a first magnification operation is received. The first page is magnified to display a magnified first page based on the first magnification operation.

Operation S2042: Switch, when determining that the first magnification operation triggers to enter a second page corresponding to a first virtual object in the first virtual scenario, from displaying the magnified first page to displaying the second page. For example, when the first magnification operation meets a trigger condition associated with a first virtual object, the display of the magnified first page is transitioned to display of a second page corresponding to the first virtual object.

By performing the magnification operation on the first page, the magnified first page shown in FIG. 3(b) is displayed. In addition, in a case that the first magnification operation satisfies a trigger condition, the magnified first page currently shown in FIG. 3(b) is switched to the second page shown in FIG. 3(c). The second page is a page corresponding to the first virtual object on the first page.

In the virtual scenario, starting from a top-layer page on which the virtual scenario is located, a user may enter a next-level page through a specified operation level by level. For example, the first page shown in FIG. 3(a) is switched, through the magnification operation, to the second page corresponding to the first virtual object.

In an example, in a case that the foregoing first magnification operation triggers to enter the second page corresponding to the first virtual object in the first virtual scenario, the switching from displaying the magnified first page to displaying the second page corresponding to the first virtual object includes:
switching, when determining based on the first magnification operation that a multiple for magnifying the first page is greater than or equal to a first preset multiple and a magnification center of the first magnification operation is located on the first virtual object, from displaying the magnified first page to displaying the second page; or
switching, when determining based on the first magnification operation that a multiple for magnifying the first page is greater than or equal to a first preset multiple and a center of the magnified first page is located on the first virtual object, from displaying the magnified first page to displaying the second page.

It is assumed that a default magnification multiple is 1. When the multiple for magnifying the first page is greater than or equal to 2 and the magnification center of the first magnification operation is located on the first virtual object, the trigger condition for page switching is satisfied. In this way, the displayed magnified first page is switched to the second page.

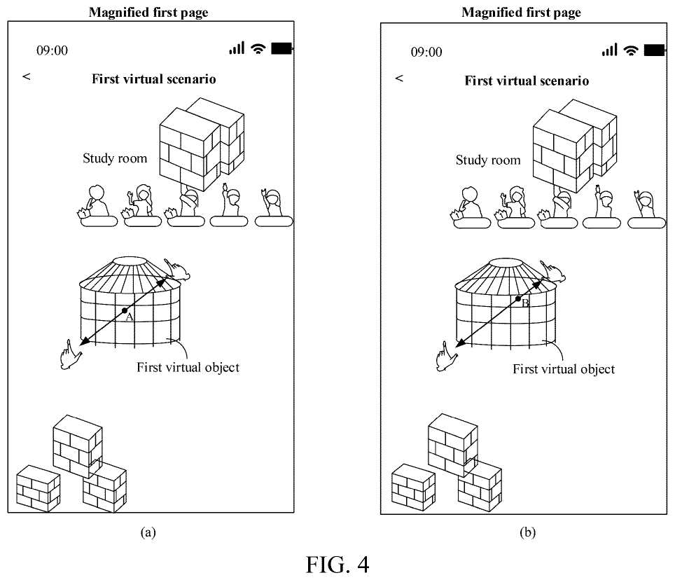

For example, as shown in FIG. 4(a), it is assumed that the first magnification operation is performed on the first page. In a case that the multiple for magnifying the first page is equal to 2 and a magnification center A of the first magnification operation is located on the virtual building, page switching is triggered. To be specific, the currently displayed magnified first page is switched to the second page.

For another example, as shown in FIG. 4(b), it is assumed that the first magnification operation is performed on the first page. In a case that the multiple for magnifying the first page is equal to 3 and a center point B of the magnified first page is located on the virtual building, page switching is also triggered. To be specific, the currently displayed magnified first page is switched to the second page.

In an embodiment, in a case that the first magnification operation is a magnification operation triggered by two fingers on a screen, a center between the two fingers on the screen is determined as the magnification center of the first magnification operation.

As shown in FIG. 4(a), the first page is magnified through a moving operation of the two fingers. In this way, a center point A of a connection line between the two fingers may be used as the magnification center of the first magnification operation, but is not limited thereto.

The moving operation of the two fingers may be keeping a position of a first finger unchanged and moving a second finger in a direction away from the first finger, or simultaneously moving a first finger and a second finger to make a distance between the fingers longer, but is not limited thereto.

In an example, a center point of a connection line formed by the two fingers placed on initial positions on the first page may be determined as the magnification center of the first magnification operation, or a center point of a connection line formed by positions of the two fingers moving in a direction away from each other by a specified distance is determined as the magnification center of the first magnification operation, but the example is not limited thereto.

In another example, the switching from displaying the magnified first page to displaying the second page corresponding to the first virtual object includes:
displaying, in a case that the first virtual object is the virtual building, a second page corresponding to the virtual building, the second page being a detail page of the virtual building, the detail page of the virtual building displaying a second virtual scenario in the virtual building, the second virtual scenario including a virtual character and/or a virtual item in the virtual building; or
displaying, in a case that the first virtual object is the virtual character, a second page corresponding to the virtual character, the second page being a detail page of the virtual character, the detail page of the virtual character displaying character information of the virtual character.

The first virtual scenario shown in FIG. 3(a) includes, but is not limited to, virtual objects such as the virtual building and the virtual character. In addition, the virtual objects carry various social entrances in a form of a map. For example, in a case that the first virtual object is the virtual building, the first magnification operation is performed, to switch from displaying the first page to displaying the second page corresponding to the virtual building. As shown in FIG. 3(c), a plurality of virtual characters in the friend square are displayed, and interaction between the virtual characters is performed in the friend square.

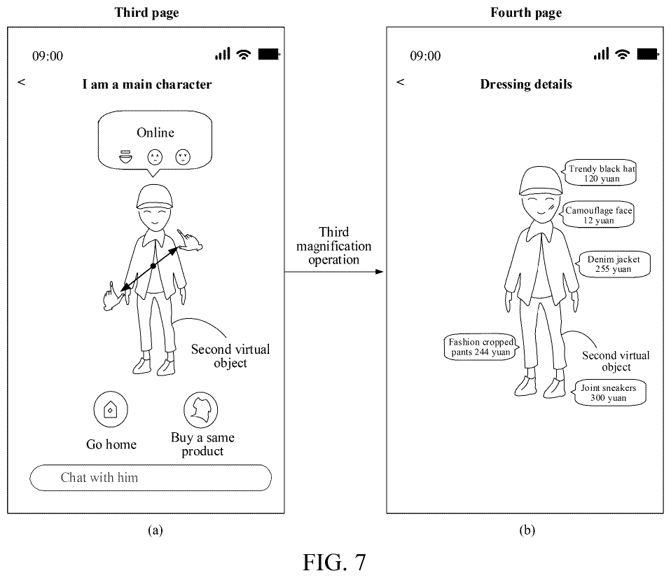

In a case that the first virtual object is the virtual character, the first magnification operation is performed to display the second page corresponding to the virtual character. For example, as shown in FIG. 7, a third magnification operation is performed on a third page on which a second virtual object (a virtual character) is located, to display a fourth page, namely, a detail page of the virtual character, and display character information (for example, dressing information of the virtual character) of the virtual character on the detail page.

The character information of the virtual character may be, but is not limited to, status information (for example, being online or offline), attribute information (for example, a level, a gender, and an age), wearing information (for example, a hat and glasses), and the like of the virtual character.

It may be learnt from FIG. 3 that the second page is the detail page of the virtual building. In other words, the second page is a next-level page of the first page. In addition, the second virtual scenario in the virtual building is displayed on the detail page. The second virtual scenario includes, but is not limited to, the virtual character, the virtual item, and the like. The second page shown in FIG. 3(c) is merely an example and is not limited.

In an example, the switching from displaying the magnified first page to displaying the second page includes:
gradually hiding the displayed magnified first page and gradually displaying the second page during magnifying the first page.

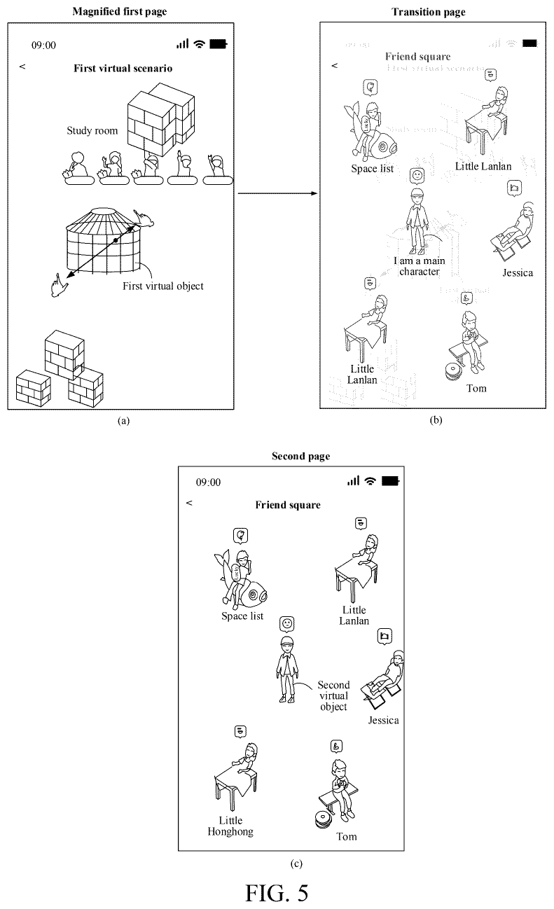

During performing the first magnification operation, it is assumed that the first magnification operation is still performed after the magnified first page shown in FIG. 5(a) appears. In this way, the first page is gradually hidden, and simultaneously, the second page is gradually displayed. In addition, a transition page shown in FIG. 5(b) appears before page switching. It may be learnt that the transition page includes the virtual object on the magnified first page and the virtual object on the second page. In other words, content displayed on the transition page is a superposition of the virtual object on the magnified first page and the virtual object on the second page.

After the transition page shown in FIG. 5(b) appears, if the first magnification operation continues to be performed, in a case that the multiple for magnifying the first page is greater than or equal to a multiple threshold a (the first preset multiple) and the magnification center of the first magnification operation is located on the first virtual object, displaying the magnified first page is switched to displaying the second page. For details, reference may be made to FIG. 5(c).

In the foregoing manner, during performing the first magnification operation, page changing situations under different perspectives may be observed, and whether the first magnification operation continues to be performed or is canceled is controlled based on the page changing situations under different perspectives, so that a detailed process of page switching is more intuitively presented, and flexibility of page switching is improved.

In an example, the second page displays at least one virtual object in the second virtual scenario, and the method further includes:
performing, in response to a second magnification operation on the second page, the following processing:
magnifying the second page and displaying a magnified second page; and
switching, when determining that the second magnification operation triggers to enter the third page corresponding to the second virtual object in the second virtual scenario, from displaying the magnified second page to displaying the third page.

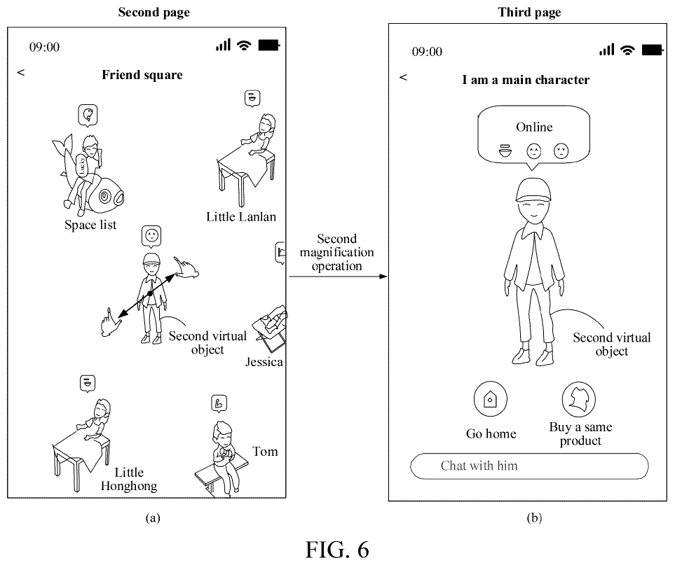

With reference to the descriptions of the foregoing embodiments, it may be learnt that, after the first magnification operation is performed on the first page, to switch a currently displayed page from the first page to the second page shown in FIG. 5(c), if the second magnification operation is performed on the second page, for example, as shown in FIG. 6(a), the second page is magnified through a moving operation of two fingers.

In a case that a multiple for magnifying the second page is greater than or equal to a multiple threshold b and a magnification center of the second magnification operation is located on the second virtual object, displaying the second page is switched to displaying the third page corresponding to the second virtual object.

For example, when the second magnification operation is performed on the second page, if the multiple for magnifying the second page satisfies the multiple threshold b (for example, being magnified two times) and the magnification center of the second magnification operation is located on the second virtual object, the trigger condition for page switching is satisfied, and the currently displayed magnified second page is switched to the third page corresponding to the second virtual object. For example, the friend square is switched to a detail page of a target virtual character. For details, reference may be made to FIG. 6(b).

A performing process of the second magnification operation is the same as that of the first magnification operation. However, a to-be-satisfied trigger condition for switching from the first page to the second page and a to-be-satisfied trigger condition for switching from the second page to the third page may be the same or may be different. For example, the multiple threshold a to be satisfied by the multiple for magnifying the first page and a value of a preset multiple threshold b to be satisfied by the multiple for magnifying the second page may be the same or may be different.

For any two times of page switching, a preset multiple threshold for each time is set based on a specific scenario. For example, a to-be-satisfied multiple threshold for page switching is set based on a size of a currently magnified page, and a preset multiple threshold may be set low when the currently magnified page is small; and the preset multiple threshold may be set high when the currently magnified page is large.

In an example, based on a performing process that is the same as the performing processes of the first magnification operation and the second magnification operation, if the third magnification operation is performed on the third page shown in FIG. 6(b), in a case that a multiple for magnifying the third page is greater than or equal to a multiple threshold c and a magnification center of the third magnification operation is located on the second virtual object, displaying a magnified third page is switched to displaying a detail page of dressing of an image corresponding to the second virtual object (the virtual character). For a detailed process, reference may be made to FIG. 7(a) and FIG. 7(b).

By performing different magnification operations on different pages, and in a case that each corresponding trigger condition is satisfied, a magnified page is switched to a next-level page of the page. This simplifies an operating operation of page switching and improves operation efficiency.

In an example, the second page displays at least one virtual object in the second virtual scenario, and the method further includes:
performing, when the first magnification operation is not ended and is continuously performed in response to the continuously performed first magnification operation on the second page, the following processing:
magnifying the second page and displaying a magnified second page; and
switching, when determining that the continuously performed first magnification operation triggers to enter the third page corresponding to the second virtual object in the second virtual scenario, from displaying the magnified second page to displaying the third page.

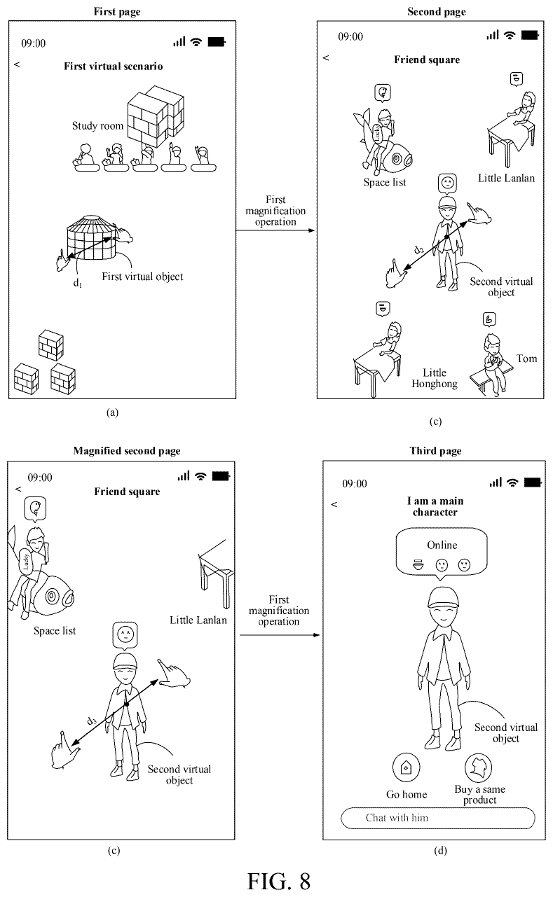

As shown in FIG. 8(a), in a case that the first magnification operation is performed on the first page and the first page is magnified by two times, the displayed first page is switched to the second page shown in FIG. 8(b), and then in a case that the first magnification operation is continuously performed and the second page is magnified by three times, the displayed magnified second page is switched to the third page. For details, reference may be made to FIG. 8(c) and FIG. 8(d).

In other words, after the first page is magnified in response to the first magnification operation and displaying the first page is switched to displaying the second page, the second page continues to be magnified in response to the first magnification operation, and a page after the second page is magnified is displayed. Until a magnification multiple of the page is greater than the preset multiple threshold, the magnified second page is switched to the third page.

In this embodiment, the first magnification operation is a magnification operation triggered by two fingers on a screen, and the continuously performed first magnification operation means that after switching from displaying the magnified first page to displaying the second page, the two fingers continue to maintain contact with the screen and the two fingers move on the screen in a direction away from each other.

In other words, continuously performing the first magnification operation may be understood as: continuously magnifying the screen through continuous moving operations by the two fingers on the screen, and switching from the first page to the second page and then switching from the second page to the third page during the continuous magnification, but is not limited thereto.

As shown in FIG. 8(a) and FIG. 8(b), it is assumed that the first magnification operation is the magnification operation triggered by the two fingers on the screen. In addition, in a case that the first magnification operation triggers to enter the second page, displaying the first page is switched to displaying the second page, and the two fingers on the second page continue to maintain contact with the screen, as shown in FIG. 8(b).

In a case that the first magnification operation is not ended and is continuously performed, by continuously moving the two fingers, the two fingers move on the screen in the direction away from each other, and the magnified second page shown in FIG. 8(c) is displayed. Finally, in a case that the multiple for magnifying the second page is greater than the preset multiple threshold, displaying the magnified second page is switched to displaying the third page corresponding to the second virtual object. For details, reference may be made to FIG. 8(d).

The two fingers move on the screen in the direction away from each other, and the first magnification operation is triggered, so that a currently displayed page is switched from the first page to the second page. After the second page is entered, the two fingers continue to move on the screen in the direction away from each other. To be specific, a distance between the two fingers further increases, and the second page is magnified. In other words, a distance d2 between the two fingers when the second page is displayed is greater than a distance di between the two fingers when the first page is displayed; and a distance d3 between the two fingers when the magnified second page is displayed is greater than the distance d2 between the two fingers when the second page is displayed.

In another example, in a virtual scenario in which man-machine interaction is implemented by using an extended reality (XR) technology, an implementation of the foregoing first magnification operation includes, but is not limited to, one of the following manners.

(1) The foregoing first magnification operation is implemented through a gesture operation when the user performs social interaction in the virtual scenario by using a wearable device.

For example, when the user wears a head-mounted display, a fully enclosed perspective is provided for the user, and the first page or the second page is magnified based on a page seen by the user in the virtual scenario through a gesture of the user opening both hands.

(2) The foregoing first magnification operation is implemented by using a handle operation device.

For example, the first page or the second page is magnified through an operation on a button or a combination operation on buttons in a Bluetooth game handle.

(3) The magnification operation on the foregoing first page is implemented in a virtual scenario of an experience game by using a somatosensory game device and through a body movement of the user.

For example, a video motion capture technology is used, and the body movement of the user is analyzed by using camera data. When the body movement satisfies a preset instruction (for example, opening arms), the first page or the second page is magnified.

By continuously performing the first magnification operation, the first page may be smoothly switched to the third page, avoiding a plurality of magnification operations on a plurality of pages, improving continuity of a page switching operation, and increasing fun of virtual social interaction.

With reference to the descriptions of the foregoing embodiments, it may be learnt that in the virtual scenario, starting from a top-layer page (or a page on which the scenario is located), the user may enter a next-level page through magnification level by level Conversely, through a minification operation, a previous-level page may be returned from a bottom-layer page level by level, specifically including:
performing, in response to a first minification operation on the third page, the following processing:
minifying the third page and displaying a minified third page; and
switching, when determining that the first minification operation triggers to enter the second page, from displaying the minified third page to displaying the second page.

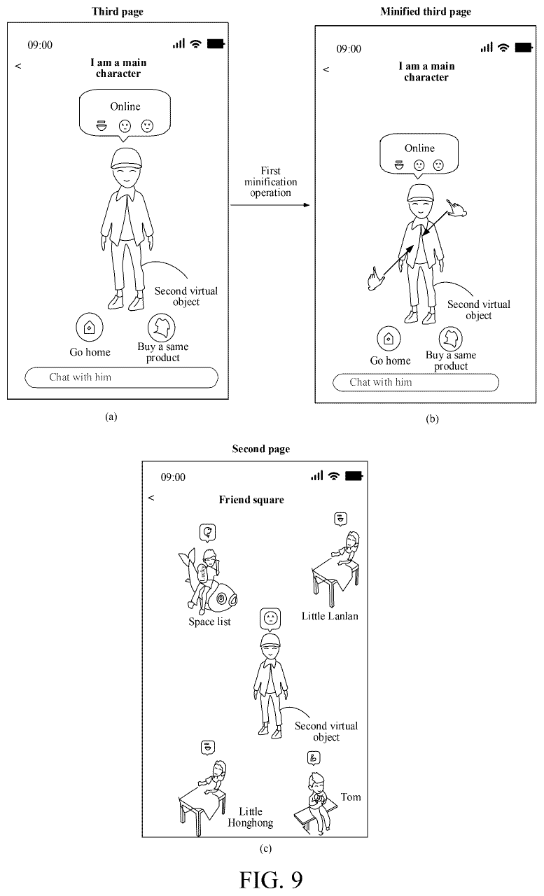

As shown in FIG. 9, in a case that the first minification operation is performed on the third page, the minified third page shown in FIG. 9(b) is displayed. The first minification operation may be moving the two fingers on the screen in a direction close to each other to reducing a display proportion of a currently displayed page with the movement of the two fingers, but is not limited thereto.

In a case that the first minification operation triggers to enter the second page, displaying the third page is switched to displaying the second page. In an example, when the third page is switched to the second page, a trigger condition needed to be satisfied by the first minification operation includes:
switching, when determining, based on the first minification operation, that a proportion for minifying the third page is less than or equal to a first preset proportion, from displaying the minified third page to displaying the second page.

As shown in FIG. 9(a) and FIG. 9(b), it is assumed that when the third page is minified to 50% of an original page, the trigger condition of the first minification operation is satisfied, and the second page shown in FIG. 9(c) is returned from the currently displayed minified third page.

Based on a similar operation, in a case that the virtual object in the second virtual scenario is displayed on the second page, the second page is minified in response to a second minification operation and a minified second page is displayed. Further, in a case that the second minification operation triggers to enter the third page displaying the first virtual object, displaying the minified second page is switched to displaying the first page.

Through the foregoing embodiment provided in this disclosure, in a case that the first minification operation is performed on the third page, and the first minification operation triggers to enter the second page, displaying the third page is switched to displaying the second page. In other words, the third page may be switched to the second page only by performing a single minification operation on the third page. This reduces an operating operation, reduces operation complexity, and implements a technical effect of improving operation efficiency.

In an example, the process of continuously performing the first magnification operation is used. The first page may be smoothly returned from the third page by continuously performing the first minification operation, specifically including:
performing, when the second page is displayed and the first minification operation is not ended and is continuously performed in response to the continuously performed first minification operation, the following processing:
minifying the second page and displaying a minified second page; and
switching, when determining that the continuously performed first minification operation triggers to enter the first page, from displaying the minified second page to displaying the first page.

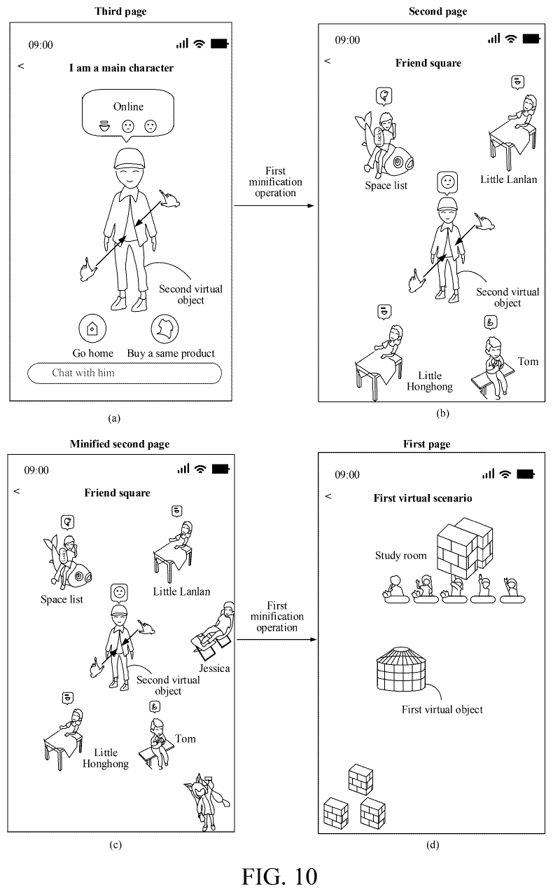

As shown in FIG. 10(a) and FIG. 10(b), it is assumed that the first minification operation is a minification operation triggered by the two fingers on the screen. In addition, in a case that the first minification operation triggers to enter the second page, displaying the third page is switched to displaying the second page, and the two fingers on the second page continue to maintain contact with the screen, as shown in FIG. 10(b).

In an example, the foregoing first minification operation is the minification operation triggered by the two fingers on the screen, and after the displayed third page is switched to the second page, the two fingers continue to maintain contact with the screen.

In a case that the second page is displayed and the first minification operation is not ended and is continuously performed, the minifying the second page in response to the continuously performed first minification operation and displaying the minified second page includes:
in a case that the second page is displayed and the two fingers move on the screen in the direction close to each other, minifying the second page in response to the first minification operation triggered by the two fingers on the screen and displaying the minified second page.

For example, in a case that the first minification operation is not ended and is continuously performed, by continuously moving the two fingers, the two fingers move on the screen in the direction close to each other, and the minified second page shown in FIG. 10(c) is displayed. Finally, in a case that a proportion for minifying the second page is less than or equal to a second preset proportion, displaying the minified second page is switched to displaying the first page. For details, reference may be made to FIG. 10(d).

The two fingers move on the screen in the direction close to each other, and the first minification operation is triggered, so that a currently displayed page is switched from the third page to the second page. After the second page is entered, the two fingers continue to move on the screen in the direction close to each other. To be specific, a distance between the two fingers further decreases, and the second page is minified. In other words, a distance between the two fingers when the second page is displayed is less than a distance between the two fingers when the first page is displayed.

In the foregoing manner, after the third page is minified in response to the first minification operation and displaying the third page is switched to displaying the second page, the second page continues to be minified in response to the first minification operation, and the magnified second page is displayed. Finally, in a case that the trigger condition is satisfied, the displayed second page is switched to the first page.

By continuously performing the first minification operation, the first page may be smoothly returned from the third page, avoiding a plurality of minification operations on a plurality of pages, and improving continuity of a page switching operation.

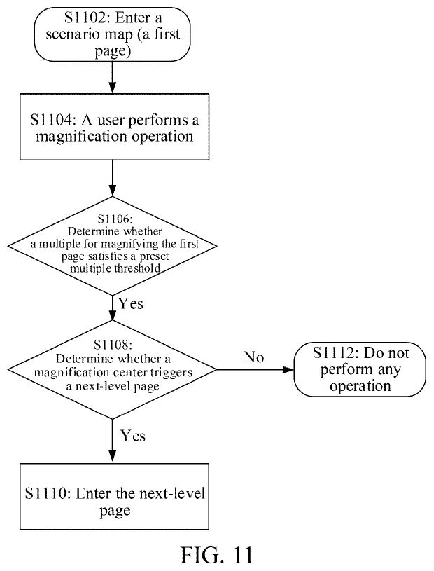

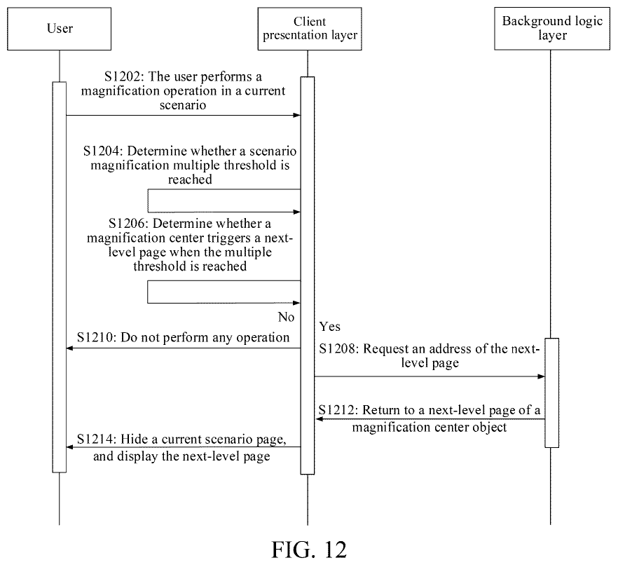

To understand the page switching method in the embodiments of this disclosure, description is further made below with reference to an overall flowchart shown in FIG. 11 and a sequence diagram shown in FIG. 12.

As shown in FIG. 11, an example in which page switching is implemented by performing a magnification operation is used. Specific operations of the foregoing page switching method include the following operations.

S1102: Enter a scenario map, namely, a first page.

As shown in FIG. 3(a), a representation form of the scenario map may include a virtual building, a virtual character, and the like shown in FIG. 3(a), but is not limited thereto.

S1104: A user performs a magnification operation in a current scenario.

The current scenario is a first virtual scenario on the first page. As shown in FIG. 3(a) and FIG. 3(b), it is assumed that the user performs a first magnification operation in the first virtual scenario. It may be learnt from the figures that, as two fingers move, a display proportion of the first page increases, and the virtual object in the virtual scenario gets bigger.

The first virtual scenario may be a local virtual scenario on the first page, but is not limited thereto. Besides, the first page may further include another virtual scenario.

S1106: Determine whether a multiple for magnifying the first page satisfies a preset multiple threshold.

For example, as shown in FIG. 3(b), it is assumed that when the first virtual scenario is magnified to twice the size of the first page, a condition of being greater than or equal to a preset multiple threshold 2 is satisfied.

S1108: Determine whether a magnification center triggers a next-level page.

For example, as shown in FIG. 3(b), it is assumed that operation S1110 is performed in a case that the first virtual scenario is magnified to twice the size of the first page and the magnification center is located on the first virtual object. Conversely, operation S1112 is performed.

The first virtual object is an entrance of a social area. In other words, there is a next-level page corresponding to the first virtual object, for example, a detail page corresponding to the first virtual object, namely, the foregoing second page.

S1110: Enter the next-level page.

For example, switching is performed from a first page shown in FIG. 3(b) to a second page shown in FIG. 3(c); or switching is performed from a second page shown in FIG. 6(a) to a third page shown in FIG. 6(b).

When page switching occurs, an initial multiple of the next-level page is entered. For example, a default magnification multiple is set to 1.

S1112: Do not perform any operation.

For example, it is assumed that a magnified first page is shown in FIG. 3(b). In this case, if an operation center of the first magnification operation is not located on the first virtual object, the magnified first page shown in FIG. 3(b) remains unchanged and no operation is performed.

To understand the foregoing page switching method, the method is described below with reference to the sequence diagram shown in FIG. 12 from an interaction process among a user, a client representation layer, and a background logic layer.

S1202: The user performs the magnification operation in the current scenario.

Through interaction between a user side and a client side, the two fingers move on a screen in a direction away from each other, thereby performing the magnification operation, for example, performing the first magnification operation in the foregoing embodiment.

S1204: Determine whether a scenario magnification multiple threshold is reached.

At the client side, whether the magnification multiple of the virtual scenario on the current page satisfies the preset multiple threshold, for example, whether the multiple for magnifying the first page shown in FIG. 3 is greater than or equal to the first preset multiple, is determined. If the preset multiple threshold is satisfied, operation S1206 is performed.

S1206: Determine whether the magnification center triggers the next-level page when the multiple threshold is reached.

As shown in FIG. 4, when the magnification multiple of the first page satisfies the first preset multiple and a magnification center A or B of the first magnification operation is located on the first virtual object, a trigger condition is satisfied, and S1208 is performed. Otherwise, operation S1210 is performed.

S1208: Request an address of the next-level page from the background logic layer.

As shown in FIG. 4, when the magnification multiple of the first page satisfies the first preset multiple and the magnification center A or B of the first magnification operation is located on the first virtual object, an access address of the second page is requested from the background, and S1212 is performed.

S1210: Do not perform any operation.

S1212: Return the access address of the second page to the client.

S1214: Hide a current scenario page and display the next-level page in a display interface of the client.

For example, as shown in FIG. 3, the magnified first page is switched to the second page.

Through the foregoing embodiment provided in this disclosure, in a case that the first magnification operation is performed on the first page, and the first magnification operation triggers to enter the second page corresponding to the first virtual object in the first virtual scenario, displaying the magnified first page is switched to displaying the second page corresponding to the first virtual object. In other words, the first page may be switched to the second page only by performing a single magnification operation on the first page. This reduces an operating operation and reduces operation complexity, thereby resolving a technical problem of low operation efficiency occurring during page switching and implementing a technical effect of improving operation efficiency.

For ease of description, the foregoing method embodiments are described as a series of action combinations. However, a person skilled in the art should know that this disclosure is not limited to the described order of the actions because some steps may be performed in another order or performed at the same time according to this disclosure. In addition, a person skilled in the art is also to learn that the embodiments described in this specification are all example embodiments, and the involved actions and modules are not necessarily required to this disclosure.

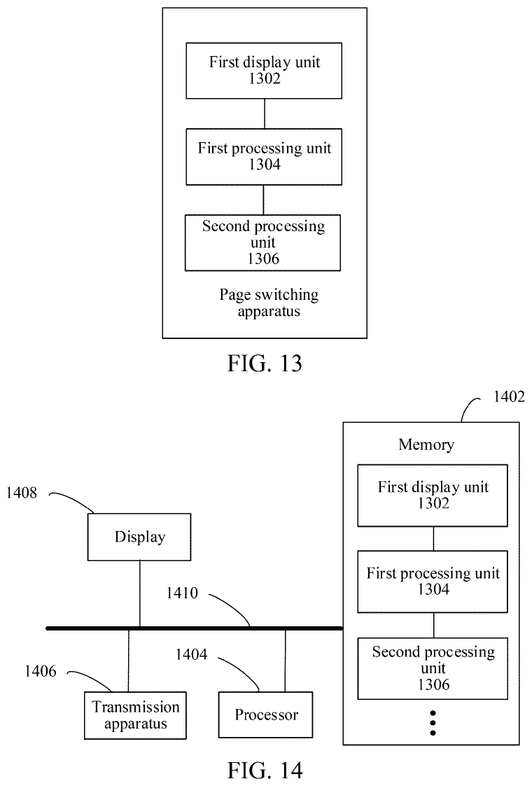

According to another aspect of the embodiments of this disclosure, a page switching apparatus shown in FIG. 13 is further provided, the apparatus including:
a first display unit 1302, configured to display a first page, the first page displaying at least one virtual object in a first virtual scenario;
a first processing unit 1304, configured to magnify the first page in response to a first magnification operation and display a magnified first page; and
a second processing unit 1306, configured to switch, when determining that the first magnification operation triggers to enter a second page corresponding to a first virtual object in the first virtual scenario, from displaying the magnified first page to displaying the second page.

The first virtual scenario on the first page shown in FIG. 3(a) includes, but is not limited to, virtual objects such as a virtual building and a virtual character. In addition, in the first virtual scenario, the virtual objects carry various social entrances in a form of a map. For example, a friend square may be entered through the virtual building. A detail page of the virtual character may be entered through the virtual character, for interaction between characters.

By performing the magnification operation on the first page, the magnified first page shown in FIG. 3(b) is displayed. In addition, in a case that the first magnification operation satisfies a trigger condition, the currently displayed magnified first page is switched to the second page shown in FIG. 3(c). The second page is a page corresponding to the first virtual object on the first page.

It may be intuitively seen from FIG. 3 that the second page is the detail page of the virtual building. In other words, the second page is a next-level page of the first page. In addition, the second virtual scenario in the virtual building is displayed on the detail page. The second virtual scenario includes, but is not limited to, the virtual character, the virtual item, and the like. The second page shown in FIG. 3(c) is merely an example and is not limited.

In some embodiments, the foregoing second processing unit 1306 includes:
a first processing module, configured to switch, when determining based on the first magnification operation that a multiple for magnifying the first page is greater than or equal to a first preset multiple and a magnification center of the first magnification operation is located on the first virtual object, from displaying the magnified first page to displaying the second page; or
switch, when determining based on the first magnification operation that a multiple for magnifying the first page is greater than or equal to a first preset multiple and a center of the magnified first page is located on the first virtual object, from displaying the magnified first page to displaying the second page.

In some embodiments, the foregoing apparatus further includes:
a third processing unit, configured to determine, when the first magnification operation is a magnification operation triggered by two fingers on a screen, a center between the two fingers on the screen as the magnification center of the first magnification operation. In some embodiments, the foregoing second processing unit includes:
a second processing module, configured to gradually hide the displayed magnified first page and gradually display the second page during magnifying the first page.

In some embodiments, the second page displays at least one virtual object in a second virtual scenario, and the apparatus further includes:
a fourth processing unit, configured to magnify the second page in response to a second magnification operation on the second page and display a magnified second page; and
a first switching unit, configured to switch, when determining that the second magnification operation triggers to enter a third page corresponding to a second virtual object in the second virtual scenario, from displaying the magnified second page to displaying the third page.

In some embodiments, the second page displays at least one virtual object in a second virtual scenario, and the apparatus further includes:
a fifth processing unit, configured to: magnify, when the first magnification operation is not ended and is continuously performed, the second page in response to the continuously performed first magnification operation on the second page, and display a magnified second page; and
a second switching unit, configured to switch, when determining that the continuously performed first magnification operation triggers to enter a third page corresponding to a second virtual object in the second virtual scenario, from displaying the magnified second page to displaying the third page.

In some embodiments, the first magnification operation is a magnification operation triggered by two fingers on a screen, and the continuously performed first magnification operation means that after switching from displaying the magnified first page to displaying the second page, the two fingers continue to maintain contact with the screen and the two fingers move on the screen in a direction away from each other.

In some embodiments, the foregoing second processing unit 1306 includes:
a first display module, configured to display, when the first virtual object is a virtual building, a second page corresponding to the virtual building, the second page being a detail page of the virtual building, the detail page of the virtual building displaying the second virtual scenario in the virtual building, the second virtual scenario comprising a virtual character and/or a virtual item in the virtual building; or
a second display module, configured to display, when the first virtual object is a virtual character, a second page corresponding to the virtual character, the second page being a detail page of the virtual character, the detail page of the virtual character displaying character information of the virtual character.

In some embodiments, the foregoing apparatus further includes:
a second display unit, configured to display the third page;
a sixth processing unit, configured to minify the third page in response to a first minification operation and display a minified third page; and
a third display unit, configured to switch, when determining that the first minification operation triggers to enter the second page, from displaying the minified third page to displaying the second page.

In some embodiments, the foregoing third display unit includes:
a fourth processing module, configured to switch, when determining, based on the first minification operation, that a proportion for minifying the third page is less than or equal to a first preset proportion, from displaying the minified third page to displaying the second page.

In some embodiments, the foregoing apparatus further includes:
a seventh processing unit, configured to: minify, when the second page is displayed and the first minification operation is not ended and is continuously performed, the second page in response to the continuously performed first minification operation on the second page, and display a minified second page; and
an eighth processing unit, configured to switch, when determining that the continuously performed first minification operation triggers to enter the first page, from displaying the minified second page to displaying the first page.

For the embodiment of the page switching apparatus herein, refer to the foregoing embodiment of the page switching method. Details are not described herein again.

According to another aspect of the embodiments of this disclosure, an electronic device for implementing the foregoing page switching method is further provided. The electronic device may be a terminal device shown in FIG. 14. In this embodiment, description is made by using an example in which the electronic device is a background device. As shown in FIG. 14, the electronic device includes a memory 1402 (e.g., a non-transitory computer-readable storage medium) and a processor 1404 (e.g., processing circuitry). The memory 1402 stores a computer program. The processor 1404 is configured to perform the steps in any one of the foregoing method embodiments through the computer program.

In some embodiments, in this embodiment, the foregoing electronic device may be located in at least one of a plurality of network devices in a computer network.

In some embodiments, in this embodiment, the foregoing processor may be configured to perform the following operations by using the computer program.

S1: Display a first page, the first page displaying at least one virtual object in a first virtual scenario.

S2: Magnify the first page in response to a first magnification operation and display a magnified first page.

S3: Switch, when determining that the first magnification operation triggers to enter a second page corresponding to a first virtual object in the first virtual scenario, from displaying the magnified first page to displaying the second page.

In some embodiments, a person of ordinary skill in the art may understand that, the structure shown in FIG. 14 is only schematic. The electronic device may alternatively be a target terminal such as a smartphone (such as an Android mobile phone or an iOS mobile phone), a tablet computer, a palmtop computer, a mobile Internet device (MID), or a PAD. FIG. 14 does not limit the structure of the electronic device. For example, the electronic device may further include more or fewer components (such as a network interface) than those shown in FIG. 14, or have a configuration different from that shown in FIG. 14.

The memory 1402 may be configured to store a software program and a module, for example, a program instruction/module corresponding to the page switching method and apparatus in the embodiments of this disclosure, and the processor 1404 performs various functional applications and data processing by running the software program and the module stored in the memory 1402, that is, implementing the foregoing page switching method. The memory 1402 may include a high-speed random access memory, and may further include a non-volatile memory such as one or more magnetic storage apparatuses, a flash memory, or another non-volatile solid-state memory. In some embodiments, the memory 1402 may further include memories remotely disposed relative to the processor 1404, and these remote memories may be connected to the terminal through a network. The foregoing examples of the network include, but are not limited to, the Internet, an intranet, a local area network, a mobile communication network, and a combination thereof. The memory 1402 may be specifically configured to store a trigger condition of the first magnification operation, a correspondence between the first virtual object and the second page, and the like, but is not limited thereto. In an example, as shown in FIG. 14, the foregoing memory 1402 may include, but is not limited to, the first display unit 1302, the first processing unit 1304, and the second processing unit 1306 in the foregoing page switching apparatus. In addition, the memory may further include, but not limited to, other modules and units in the foregoing page switching apparatus. Details are not described herein again.

In some embodiments, the transmission apparatus 1406 is configured to receive or transmit data through a network. Specific examples of the network include a wired network and a wireless network. In an example, the transmission apparatus 1406 includes a network interface controller (NIC). The NIC may be connected to another network device and a router by using a network cable to communicate with the Internet or a local area network. In an example, the transmission apparatus 1406 is a radio frequency (RF) module, and is configured to communicate with the Internet in a wireless manner.

In addition, the foregoing electronic device further includes a display 1408, configured to display a target message transmitted by a target account; and a connection bus 1410, configured to connect various module components in the electronic device.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In other embodiments, the target terminal or the server may be a node in a distributed system, where the distributed system may be a blockchain system, and the blockchain system may be a distributed system formed by connecting a plurality of nodes in through network communication. A peer to peer (P2P) network may be formed between the nodes. A computing device in any form, for example, an electronic device such as a server or a terminal, may become a node in the blockchain system by joining the P2P network.

According to an aspect of this disclosure, a computer program product or a computer program is provided, the computer program product or the computer program including computer instructions, the computer instructions being stored in a computer-readable storage medium. A processor of a computer device reads the computer instructions from the computer-readable storage medium, and executes the computer instructions, so that the computer device performs the page switching method provided in the example implementations in the foregoing aspects such as server verification processing, where the computer program, when run, is configured for performing the operations in any foregoing method embodiments.

In some embodiments, in this embodiment, the computer-readable storage medium may be configured to store a computer program configured to perform the following operations.

S1: Display a first page, the first page displaying at least one virtual object in a first virtual scenario.

S2: Magnify the first page in response to a first magnification operation and display a magnified first page.

S3: Switch, when determining that the first magnification operation triggers to enter a second page corresponding to a first virtual object in the first virtual scenario, from displaying the magnified first page to displaying the second page.

In some embodiments, in this embodiment, a person of ordinary skill in the art may understand that all or some of the operations of the methods in the foregoing embodiments may be implemented by a program instructing relevant hardware of the target terminal. The program may be stored in a computer-readable storage medium, such as a non-transitory computer-readable storage medium. The storage medium may comprise: a flash disk, a read-only memory (ROM), a random access memory (RAM), a magnetic disk, or an optical disc.

The sequence numbers of the foregoing embodiments of this disclosure are merely for description purpose, and do not indicate the preference among the embodiments.

When the integrated unit in the foregoing embodiments is implemented in the form of a software function unit and sold or used as an independent product, the integrated unit may be stored in the foregoing computer-readable storage medium. Based on such an understanding, technical solutions of this disclosure may be expressed in a form of a software product. The computer software product is stored in a storage medium and includes several instructions for instructing one or more computer devices (which may be a personal computer, a server, or a network device) to perform all or some of the operations of the methods in the embodiments of this disclosure.

In the foregoing embodiments of this disclosure, the descriptions of the embodiments have respective focuses. For a part that is not described in detail in an embodiment, refer to related descriptions in other embodiments.

In the several embodiments provided in this disclosure, it is to be understood that the disclosed client may be implemented in other manners. The described apparatus embodiments are merely examples. For example, the unit division is merely logical function division, and may use other division manners during actual implementation. For example, a plurality of units or components may be combined or integrated into another system, or some features may be omitted or not performed. In addition, the displayed or discussed mutual couplings or direct couplings or communication connections may be implemented through some interfaces. The indirect couplings or communication connections between the units or modules may be implemented in electronic or another form.

The units described as separate parts may or may not be physically separate, and components displayed as units may or may not be physical units, that is, may be located in one position, or may be distributed on a plurality of network units. Some or all of the units may be selected according to an actual requirement to achieve the objectives of the solutions in the embodiments.

In addition, functional units in the embodiments of this disclosure may be integrated into one processing unit, or each of the units may exist alone physically, or two or more units are integrated into one unit. The integrated unit may be implemented in the form of hardware, or may be implemented in the form of a software function unit.

The foregoing descriptions are example implementations of this disclosure. A person of ordinary skill in the art may make some improvements and modifications without departing from the principle of this disclosure and the improvements and modifications shall fall within the protection scope of this disclosure.

What is claimed is:

1. A method for switching pages in a virtual environment, the method comprising:
displaying a first page including at least one virtual object in a first virtual environment;
receiving a first magnification operation;
magnifying the first page to display a magnified first page based on the first magnification operation; and
when the first magnification operation meets a trigger condition associated with a first virtual object, transitioning from the display of the magnified first page to display of a second page corresponding to the first virtual object.

2. The method according to claim 1, wherein
the trigger condition is met when a magnification factor of the first page is greater than or equal to a threshold and when a magnification center of the first magnification operation is located on the first virtual object.

3. The method according to claim 1, wherein
the trigger condition is met when a magnification factor of the first page is greater than or equal to a threshold and when a center of the magnified first page is located on the first virtual object.

4. The method according to claim 2, wherein
when the first magnification operation is performed using two fingers on a touchscreen, the magnification center is determined as a center between the two fingers.

5. The method according to claim 1, wherein the transitioning comprises:
cancelling the display of the magnified first page; and
displaying the second page while magnifying the first page based on the first magnification operation.

6. The method according to claim 1, wherein:
the second page includes at least one virtual object in a second virtual environment; and
the method further comprises:
receiving a second magnification operation on the second page;
based on the second magnification operation, magnifying the second page to display a magnified second page; and
when the second magnification operation meets a second trigger condition associated with a second virtual object, transitioning from the display of the magnified second page to display of a third page corresponding to the second virtual object.

7. The method according to claim 1, wherein
the second page includes at least one virtual object in a second virtual environment; and
the method further comprises:
detecting a continuation of the first magnification operation on the second page;
based on the continued first magnification operation, magnifying the second page to display a magnified second page; and
when the continued first magnification operation meets a second trigger condition associated with a second virtual object, transitioning from the display of the magnified second page to display of a third page corresponding to the second virtual object.

8. The method according to claim 7, wherein the first magnification operation is initiated by two touch inputs a touchscreen and moving the two touch inputs apart on the touchscreen; and
the continued first magnification operation includes the two touch inputs via the touchscreen being maintained and continuing to move apart after the transition to the display of the second page.

9. The method according to claim 1, wherein
when the first virtual object is a virtual building, the second page is a detail page of the virtual building, and the detail page displays a second virtual environment within the virtual building, including at least one of a virtual character or a virtual item.

10. The method according to claim 1, wherein
when the first virtual object is a virtual character, the second page is a detail page of the virtual character, and the detail page displays character information of the virtual character.

11. The method according to claim 6, further comprising:
receiving a first reduction operation on the third page;
based on the first reduction operation, reducing a size of the third page to display a reduced third page; and
when the first reduction operation meets a reduction trigger condition, transitioning from the display of the reduced third page to the display of the second page.

12. The method according to claim 11, wherein the reduction trigger condition is met when a reduction factor of the third page is less than or equal to a threshold.

13. The method according to claim 11, further comprising:
detecting a continuation of the first reduction operation on the second page;
based on the continued first reduction operation,
reducing a size of the second page to display a reduced second page; and
when the continued first reduction operation meets a second reduction trigger condition, transitioning from the display of the reduced second page to display of the first page.

14. An apparatus, comprising:
processing circuitry configured to:
display a first page including at least one virtual object in a first virtual environment;
receive a first magnification operation;
magnify the first page to display a magnified first page based on the first magnification operation; and
when the first magnification operation meets a trigger condition associated with a first virtual object, transition from the display of the magnified first page to display of a second page corresponding to the first virtual object.

15. The apparatus according to claim 14, wherein
the trigger condition is met when a magnification factor of the first page is greater than or equal to a threshold and when a magnification center of the first magnification operation is located on the first virtual object.

16. The apparatus according to claim 14, wherein
the trigger condition is met when a magnification factor of the first page is greater than or equal to a threshold and when a center of the magnified first page is located on the first virtual object.

17. The apparatus according to claim 15, wherein
when the first magnification operation is performed using two fingers on a touchscreen, the magnification center is determined as a center between the two fingers.

18. The apparatus according to claim 14, wherein the processing circuitry is configured to:
cancel the display of the magnified first page; and
transition to the display of the second page while magnifying the first page based on the first magnification operation.

19. The apparatus according to claim 14, wherein
the second page includes at least one virtual object in a second virtual environment; and
the processing circuitry is configured to:
receive a second magnification operation on the second page;
based on the second magnification operation, magnify the second page to display a magnified second page; and
when the second magnification operation meets a second trigger condition associated with a second virtual object, transition from the display of the magnified second page to display of a third page corresponding to the second virtual object.

20. A non-transitory computer-readable storage medium, storing instructions which when executed by a processor cause the processor to perform:
displaying a first page including at least one virtual object in a first virtual environment;
receiving a first magnification operation;
magnifying the first page to display a magnified first page based on the first magnification operation; and
when the first magnification operation meets a trigger condition associated with a first virtual object, transitioning from the display of the magnified first page to display of a second page corresponding to the first virtual object.
